(19) United States
(12) Patent Application Publication
(10) Pub. No.: US 2026/0163152 A1
(43) Pub. Date: Jun. 11, 2026

(54) BATTERY PACK

(71) Applicant: HONDA MOTOR CO., LTD., Tokyo (JP)

(72) Inventors: Kenzo IKEDA, Tokyo (JP); Yoshitaka Kunimatsu, Tokyo (JP); Kotaro Kikuchi, Tokyo (JP); Yuji Haga, Tokyo (JP)

(73) Assignee: HONDA MOTOR CO., LTD., Tokyo (JP)

(21) Appl. No.: 19/412,884

(22) Filed: Dec. 9, 2025

(30) Foreign Application Priority Data
Dec. 11, 2024 (JP) 2024-216542

(51) Int. Cl. H01M 50/242; B60L 50/64; H01M 10/42; H01M 50/249

(52) U.S. Cl. CPC H01M 50/242; H01M 10/425; H01M 50/249; B60L 50/64; H01M 2220/20

(57) ABSTRACT

A battery pack includes: a battery; an electrical device connected to the battery; a case including a case body accommodating the battery and the electrical device, and a case cover; and a reinforcing member provided inside the case, the case body has a bottom wall on which the battery and the electrical device are placed, and a side wall extending in a first direction parallel to the bottom wall, the electrical device is disposed adjacent to the side wall in a second direction parallel to the bottom wall and perpendicular to the first direction, the reinforcing member includes a partition plate disposed adjacent to the electrical device in the first direction and adjacent to the side wall in the second direction, and the partition plate, as viewed in the first direction, is formed in a triangular shape, and includes a bulging portion as defined herein.

### CROSS-REFERENCE TO RELATED APPLICATION

This application is based on and claims priority under 35 USC 119 from Japanese Patent Application No. 2024-216542 on Dec. 11, 2024.

### TECHNICAL FIELD

The present invention relates to a battery pack to be mounted on a vehicle.

### BACKGROUND ART

In recent years, researches and developments have been conducted on a secondary battery which contributes to improvement in energy efficiency in order to allow more people to have access to affordable, reliable, sustainable and advanced energy.

In a protection structure for a battery pack described in Patent Literature 1, a protection cover including an upper-surface cover portion covering an upper surface of the battery pack and a side-surface cover portion covering side surfaces of the battery pack is attached to a vehicle body. The upper-surface cover portion is provided with a fragile portion, and when an external force is applied to the side-surface cover portion in an arrangement direction of the upper-surface cover portion and the side-surface cover portion, the upper-surface cover portion is bent or broken starting from the fragile portion. Accordingly, an impact acting on the battery pack is alleviated.

A battery pack described in Patent Literature 2 includes a battery and a high-voltage component connected to the battery, and a storage box that stores the battery and the high-voltage component has a load transmission part that transmits a load acting on the storage box. The high-voltage component is structurally connected to the load transmission part and is displaced together with the load transmission part to be separated from the battery when a collision occurs. Accordingly, an occurrence of accidental short-circuiting or the like due to contact between the high-voltage component and the battery is prevented.

Patent Literature 1: JP2018-106811A

Patent Literature 2: JP2021-167150A

### SUMMARY OF INVENTION

An object of the present invention is to generate, when a load is input to a case of a battery pack, a reaction force against the input load to protect an electrical device accommodated in the case.

An aspect of the present invention is a battery pack including:
a battery;
an electrical device connected to the battery;
a case including a case body accommodating the battery and the electrical device, and a case cover covering an upper side of the case body; and
a reinforcing member provided inside the case, in which
the case body has a bottom wall on which the battery and the electrical device are placed, and a side wall extending in a first direction parallel to the bottom wall,
the electrical device is disposed adjacent to the side wall in a second direction parallel to the bottom wall and perpendicular to the first direction,
the reinforcing member includes a partition plate disposed adjacent to the electrical device in the first direction and adjacent to the side wall in the second direction, and
the partition plate
   as viewed in the first direction, is formed in a triangular shape having a base side extending toward the side wall of the case body along the second direction, an oblique side inclined such that the oblique side departs from the base side toward the side wall, and a facing side facing the side wall in the second direction, and
   includes a bulging portion that is a part of the partition plate including an upper end portion of the partition plate at which the oblique side and the facing side intersect each other and extending from the oblique side to the facing side, and that bulges toward a side opposite to the electrical device along the first direction.

According to the present invention, when a load is input to the case of the battery pack, a reaction force against the input load can be generated to protect the electrical device accommodated in the case.

### BRIEF DESCRIPTION OF DRAWINGS

FIG. 1 is a schematic diagram of an example of a vehicle for illustrating an embodiment of the present invention.

FIG. 2 is an exploded perspective view of a battery pack mounted on the vehicle of FIG. 1.

FIG. 3 is a perspective view of a reinforcing member including a case body of the battery pack of FIG. 2 and a partition plate.

FIG. 4 is a perspective view of the reinforcing member of FIG. 3.

FIG. 5 is a plan view of the partition plate of FIG. 3.

FIG. 6 is a side view of the partition plate of FIG. 3.

FIG. 7 is a side view of a modification of the partition plate of FIG. 3.

FIG. 8 is a side view showing how the partition plate of FIG. 3 is deformed.

FIG. 9 is a plan view showing how the partition plate of FIG. 3 is deformed.

FIG. 10 is a rear view showing how the partition plate of FIG. 3 is deformed.

### DESCRIPTION OF EMBODIMENTS

An example of a vehicle according to an embodiment of the present invention will be described with reference to the accompanying drawings. The drawings are viewed from directions of reference numerals. In the present specification and the like, in order to simplify and clarify the description, a front-rear direction, a left-right direction, and an upper-lower direction are described according to a direction viewed from a driver of a vehicle, and in the drawings, a front side of the vehicle is shown as Fr, a rear side is shown as Rr, a left side is shown as L, a right side is shown as R, an upper side is shown as U, and a lower side is shown as D.

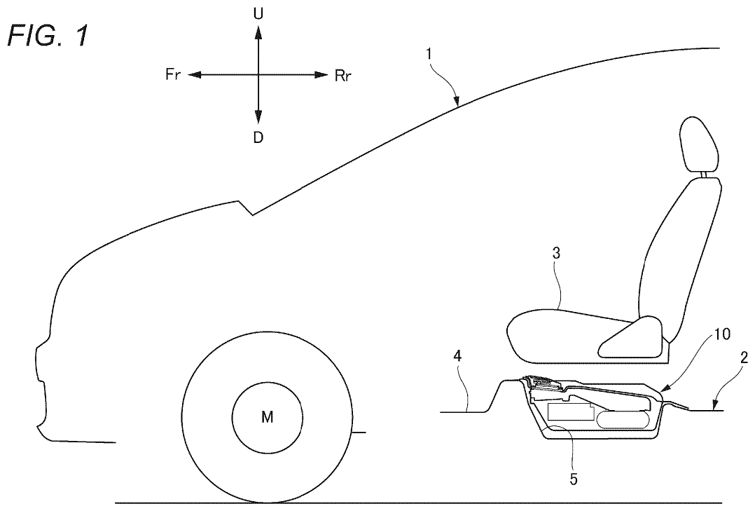

A vehicle 1 shown in FIG. 1 is an electric vehicle such as a battery electric automobile, a hybrid vehicle (including a plug-in hybrid vehicle), or a fuel cell vehicle. The vehicle 1 includes a vehicle body 2, a seat 3, and a battery pack 10. The vehicle body 2 constitutes a framework of the vehicle 1, and the battery pack 10 stores and discharges electric power to be supplied to a motor M or the like serving as a drive source of the vehicle.

The vehicle body 2 includes a floor panel 4. The floor panel 4 constitutes a part of the framework of a vehicle lower part. Although not shown, the vehicle body 2 may include, as members constituting the framework of the vehicle lower part, a pair of side sills extending in a vehicle front-rear direction along both side portions of the floor panel 4, a cross member bridged between the pair of side sills, and the like. The seat 3 is installed on the floor panel 4.

The battery pack 10 is also installed on the floor panel 4, and is located below the seat 3 in the example shown in FIG. 1. A recessed portion 5 is formed in the floor panel 4, and the battery pack 10 is accommodated in the recessed portion 5. An interior space of the vehicle 1 can be enlarged by accommodating the battery pack 10 in a space under the seat that is a dead space.

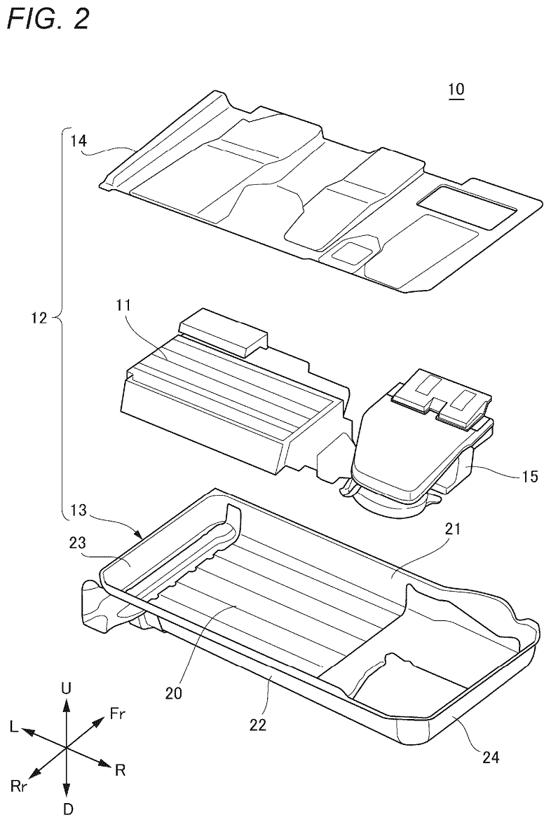

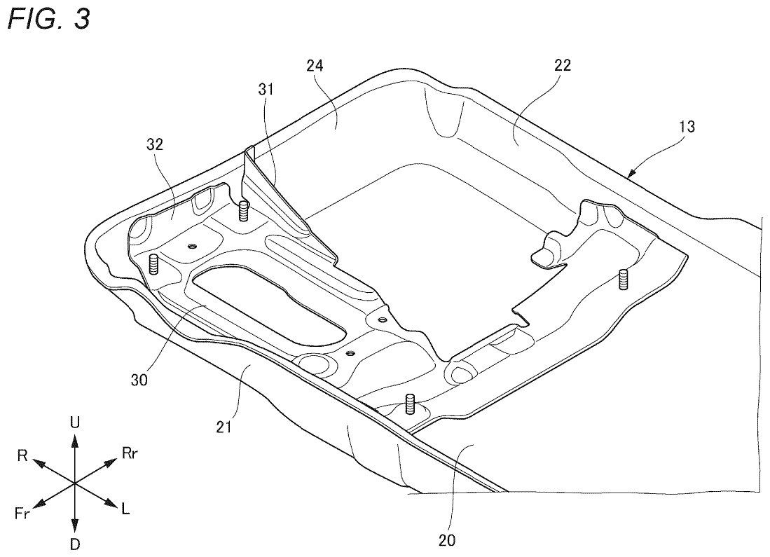

As shown in FIGS. 2 and 3, the battery pack 10 includes batteries 11 and a case 12 that accommodates the batteries 11. Each of the batteries 11 includes a plurality of battery cells. The battery cell is, for example, a lithium-ion battery or nickel-hydrogen battery using a liquid electrolyte, or an all-solid-state battery using a solid electrolyte. The battery 11 is typically modularized in a state where the plurality of battery cells are connected in series and/or in parallel.

The case 12 includes a case body 13 and a case cover 14. The case body 13 is formed in a tray shape capable of accommodating the batteries 11. The case body 13 is, for example, formed by a plate member made of metal such as an aluminum alloy or steel. The case cover 14 covers an upper side of the case body 13. The case cover 14 is formed by a steel plate.

The case 12 further accommodates electrical devices such as a junction box 15 and a bus bar. The junction box 15 controls a connection between a charging system mounted on the vehicle and the battery pack 10, and a connection between an inverter that drives the motor M and the battery pack 10. The bus bar connects the modularized batteries 11 and connects the batteries 11 and the junction box 15.

The case body 13 formed in a tray shape includes a bottom wall 20 on which batteries 11 and the junction box 15 are placed, and side walls 21, 22, 23, and 24 extending upward from an edge of the bottom wall 20. The side walls 21 and 22 are disposed facing each other in the vehicle front-rear direction, and each extends in a vehicle width direction. The side walls 23 and 24 are disposed facing each other in the vehicle width direction, and each extends in the vehicle front-rear direction. The batteries 11 and the junction box 15 are disposed adjacently in the vehicle width direction, the batteries 11 are disposed adjacent to the left side wall 23 in the vehicle width direction, and the junction box 15 is disposed adjacent to the right side wall 24 in the vehicle width direction.

As shown in FIGS. 3 to 6, the battery pack 10 includes a fixing plate 30, a partition plate 31, and a doubling plate 32 as a reinforcing member provided inside the case 12.

The fixing plate 30 fixes the junction box 15 and the batteries 11 to the bottom wall 20 of the case body 13. The fixing plate 30 is disposed between the junction box 15, the batteries 11 and the bottom wall 20, and is joined to the bottom wall 20 by an appropriate method such as welding or fastening using a bolt or a rivet. The junction box 15 and the batteries 11 are installed on an upper surface of the fixing plate 30 and fastened to the fixing plate 30 by bolts and nuts. The junction box 15 and the batteries 11 are fixed to the bottom wall 20 via the fixing plate 30 joined to the bottom wall 20.

The partition plate 31 protects the junction box 15 by generating a reaction force against a side collision load input to a side portion of the case 12 in the vehicle width direction. The partition plate 31 is disposed adjacent to the junction box 15 in the vehicle front-rear direction, and is disposed adjacent to the right side wall 24 of the case body 13 in the vehicle width direction.

The partition plate 31 is formed in a substantially triangular shape as viewed in the vehicle front-rear direction, and has a base side 40 extending toward the side wall 24 along the vehicle width direction, an oblique side 41 inclined such that the oblique side 41 departs from the base side 40 toward the side wall 24, and a facing side 42 facing the side wall 24 in the vehicle width direction. The partition plate 31 has an abutting portion 43 extending from the facing side 42 to a side opposite to the junction box 15 along the vehicle front-rear direction, and a cutout 44 is provided at a corner portion of the partition plate 31 at which the facing side 42 and the base side 40 intersect each other.

A gap G1 between the facing side 42 and the abutting portion 43 of the partition plate 31 and the side wall 24 is smaller than a gap G2 between the junction box 15 and the side wall 24. When the side collision load is input to a side portion of the case 12 on a side wall 24 side, the side wall 24 and a side portion of the case cover 14 overlapping the side wall 24 are deformed inward, but the facing side 42 and the abutting portion 43 of the partition plate 31 are abutted with the side wall 24 and the side portion of the case cover 14 earlier than the junction box 15 and a reaction force is generated. Accordingly, the inward deformation of the side wall 24 and the side portion of the case cover 14 is prevented.

The doubling plate 32 increases rigidity of a side portion of the case 12 in the vehicle width direction and protects the junction box 15. The doubling plate 32 is disposed between the junction box 15 and the right side wall 24 of the case body 13, and is joined to the side wall 24 by an appropriate method such as welding. In other words, the doubling plate 32 extends along the side wall 24 within a range in which the junction box 15 and the side wall 24 face each other. A portion of the side wall 24 facing the facing side 42 and the abutting portion 43 of the partition plate 31 is out of the range in which the doubling plate 32 extends.

Rigidity of the side wall 24 is increased over a range in which the doubling plate 32 extends, and the inward deformation of the side wall 24 due to the side collision load is prevented. The inward deformation of the side wall 24 is guided to the portion of the side wall 24 facing the partition plate 31 and is received by the partition plate 31.

From a viewpoint of increasing the rigidity of the side wall 24 of the case body 13 and controlling the deformation of the side wall 24, an upper end of the doubling plate 32 is preferably located lower than an upper end of the side wall 24. Meanwhile, since the partition plate 31 also receives an input from a side portion of the case cover 14 overlapping the side wall 24, an upper end of the facing side 42 of the partition plate 31 is preferably located higher than the upper end of the side wall 24.

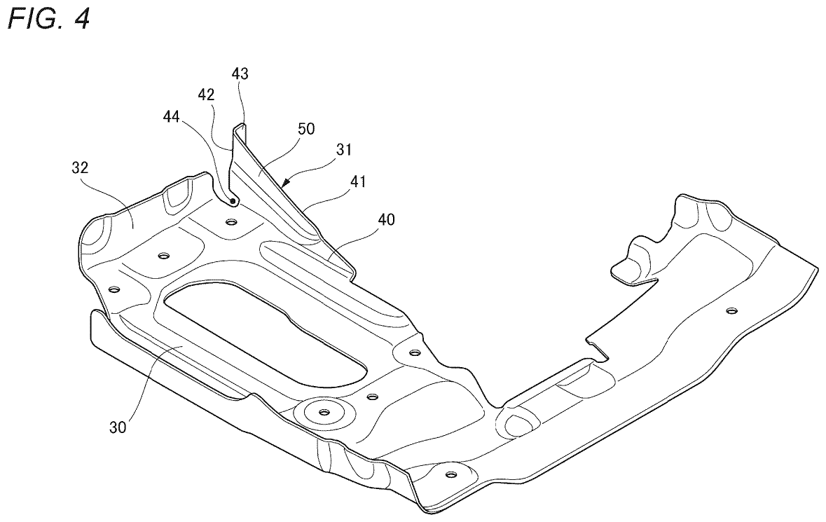

The fixing plate 30, the partition plate 31, and the doubling plate 32 may be formed as separate members, but are preferably integrally formed as shown in FIGS. 3 and 4. In the example shown in FIGS. 3 and 4, the fixing plate 30, the partition plate 31, and the doubling plate 32 are formed by a plate member made of metal such as an aluminum alloy or steel, and the partition plate 31 and the doubling plate 32 extend from the fixing plate 30 and are bent and raised relative to the fixing plate 30. By integrally forming the fixing plate 30, the partition plate 31, and the doubling plate 32, the number of components is reduced, adjustment in a positional relationship therebetween is also eliminated, and assemblability of the battery pack 10 is also improved.

In a case where the fixing plate 30, the partition plate 31, and the doubling plate 32 are integrally formed, the partition plate 31 and the doubling plate 32 that are bent and raised relative to the fixing plate 30 are preferably separated from each other from a viewpoint of enhancing formability and securing functional independence of each plate.

The partition plate 31 is deformed by the abuttment with the side wall 24 and the side portion of the case cover 14 overlapping the side wall 24. In order to prevent the deformed partition plate 31 from coming into contact with the junction box 15, a bulging portion 50 is provided in a part of the partition plate 31, and deformation of the partition plate 31 is controlled.

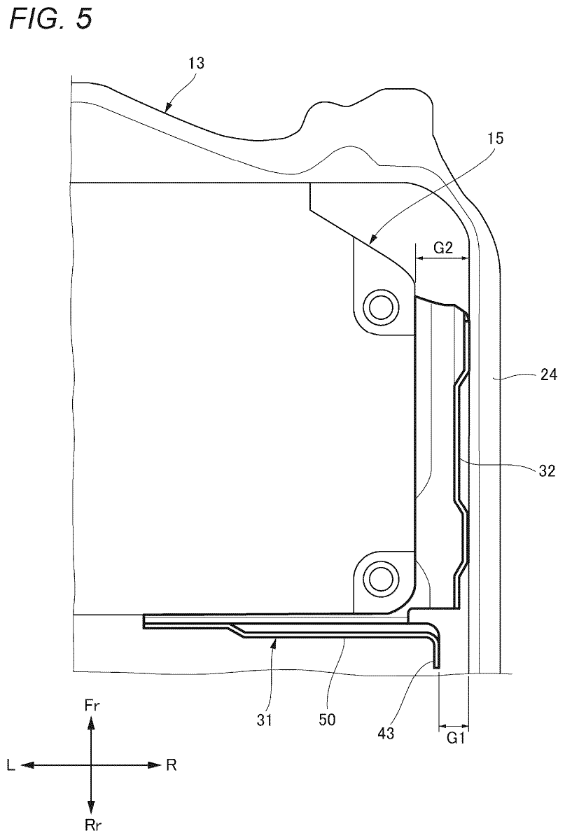

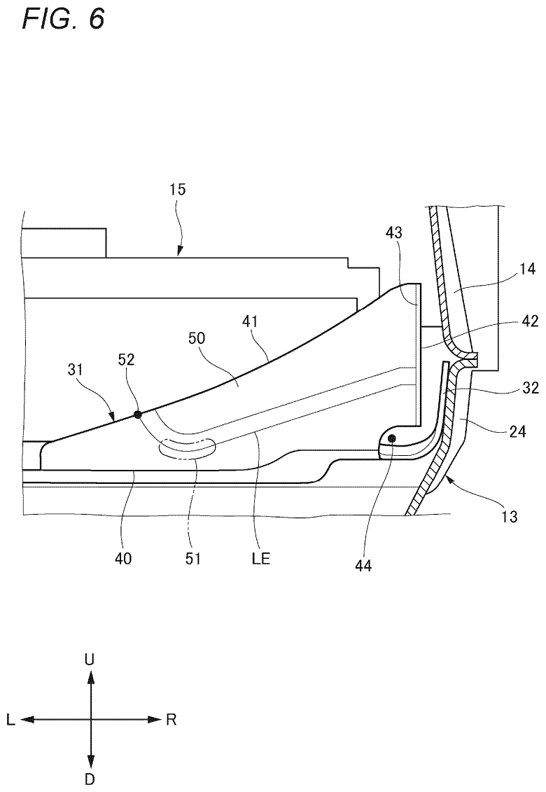

As shown in detail in FIGS. 5 and 6, the bulging portion 50 is a part of the partition plate 31 including an upper end portion of the partition plate 31 at which the oblique side 41 and the facing side 42 intersect each other and extending from the oblique side 41 to the facing side 42. The bulging portion 50 bulges to a side opposite to the junction box 15 along the vehicle front-rear direction in which the partition plate 31 and the junction box 15 are adjacent to each other.

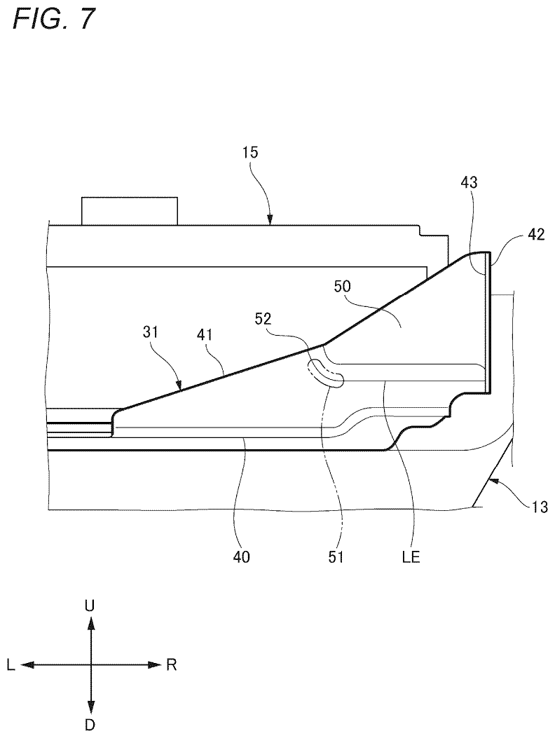

A bent portion 51 is provided at a lower edge LE of the bulging portion 50 extending from the oblique side 41 to the facing side 42. The bent portion 51 is located closer to the facing side 42 than a start point 52 of the lower edge LE on the oblique side 41 and is located lower than the start point 52. In the example shown in FIG. 6, the lower edge LE of the bulging portion 50 extends along the oblique side 41 from the bent portion 51 to the facing side 42, but may extend along the base side 40 as shown in FIG. 7.

The start point 52 of the lower edge LE of the bulging portion 50 on the oblique side 41 is located lower than the upper end of the side wall 24 of the case body 13.

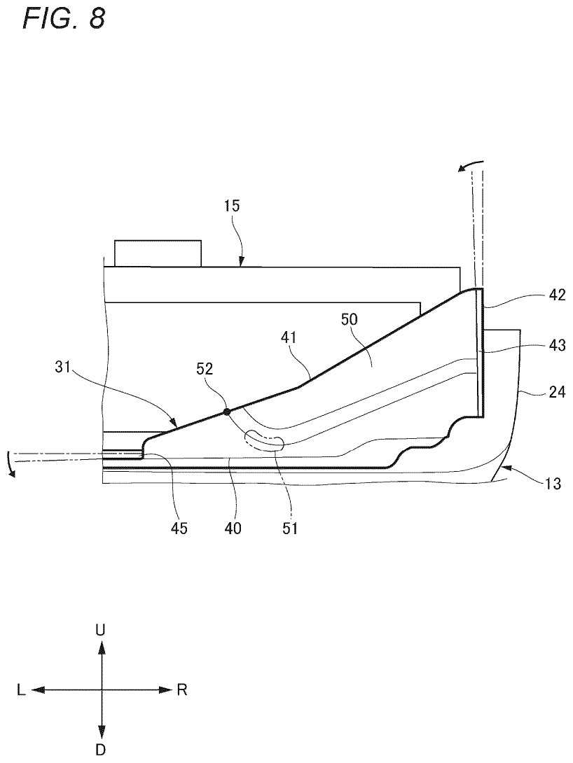

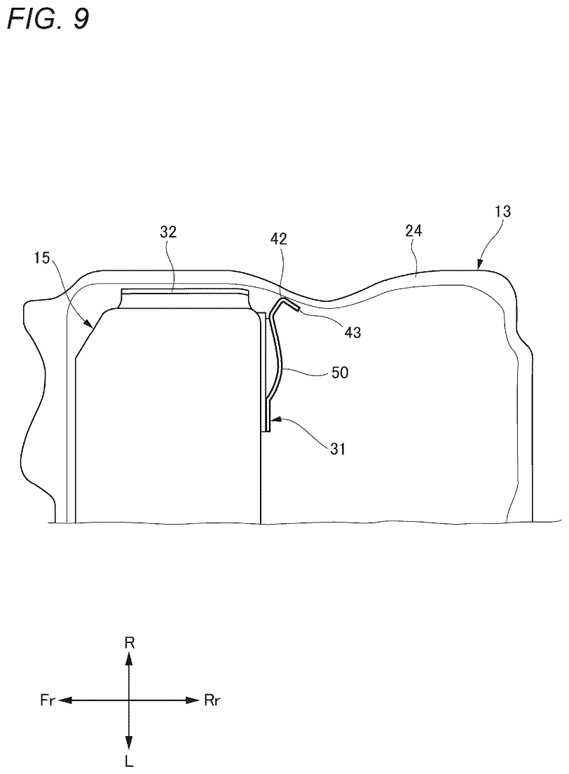

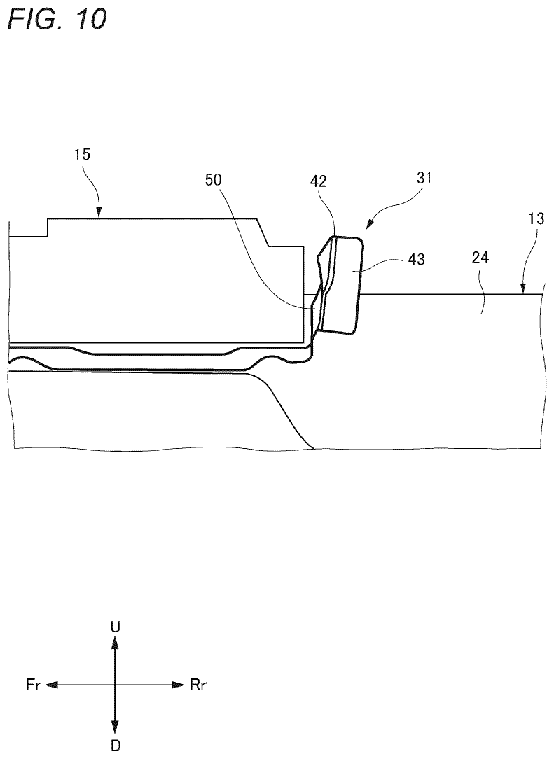

FIGS. 8 to 10 show how the partition plate 31 is deformed.

First, due to the abuttment between the partition plate 31 and the side wall 24 of the case body 13 and the side portion of the case cover 14 overlapping the side wall 24, a distal end 45, which is one end of the base side 40 of the partition plate 31 and is opposite to the side wall 24 side, is lowered, and the facing side 42 and the abutting portion 43 are inclined rearward relative to the side wall 24. A compressive force along the oblique side 41 acts on the partition plate 31.

The partition plate 31 on which the compressive force acts is crushed in the vehicle width direction which is an extending direction of the partition plate 31 while bulging in one direction along the vehicle front-rear direction which is a thickness direction of the partition plate 31. Since the bulging portion 50 bulges in advance to the side opposite to the junction box 15 along the vehicle front-rear direction, the bulging of the partition plate 31 due to the deformation is guided to the side opposite to the junction box 15. Accordingly, contact between the deformed partition plate 31 and the junction box 15 is prevented.

If the bent portion 51 is provided at the lower edge LE of the bulging portion 50, and the bent portion 51 is located closer to the facing side 42 than the start point 52 of the lower edge LE on the oblique side 41 and is located lower than the start point 52, the bulging of the partition plate 31 due to the deformation occurs starting from the bent portion 51. Accordingly, the bulging of the partition plate 31 due to the deformation can be controlled, and the contact between the deformed partition plate 31 and the junction box 15 can be more reliably prevented.

If the start point 52 of the lower edge LE of the bulging portion 50 on the oblique side 41 is located lower than the upper end of the side wall 24 of the case body 13, a load input point on the partition plate 31 overlaps the bulging portion 50 as viewed in the vehicle width direction. Accordingly, the compressive force can be effectively applied to the bulging portion 50.

The abutting portion 43 of the partition plate 31 prevents the facing side 42 of the partition plate 31 from being displaced toward the junction box 15. Accordingly, the contact between the deformed partition plate 31 and the junction box 15 can be more reliably prevented. If the cutout 44 is provided at the corner portion of the partition plate 31 at which the facing side 42 and the base side 40 intersect each other, an edge portion of the partition plate 31 along the facing side 42 and overlapping the cutout 44 can be buckled toward the side opposite to the junction box 15. Accordingly, the contact between the deformed partition plate 31 and the junction box 15 can be more reliably prevented.

In the present description, at least the following matters are described.

(1) A battery pack including:
a battery (battery 11);
an electrical device (junction box 15) connected to the battery;
a case (case 12) including a case body (case body 13) accommodating the battery and the electrical device, and a case cover (case cover 14) covering an upper side of the case body;
a reinforcing member provided inside the case, in which
the case body has a bottom wall (bottom wall 20) on which the battery and the electrical device are placed, and a side wall (side wall 24) extending in a first direction parallel to the bottom wall,
the electrical device is disposed adjacent to the side wall in a second direction parallel to the bottom wall and perpendicular to the first direction,
the reinforcing member includes a partition plate (partition plate 31) disposed adjacent to the electrical device in the first direction and adjacent to the side wall in the second direction, and
the partition plate
   as viewed in the first direction, is formed in a triangular shape having a base side (base side 40) extending toward the side wall of the case body along the second direction, an oblique side (oblique side 41) inclined such that the oblique side departs from the base side toward the side wall, and a facing side (facing side 42) facing the side wall in the second direction, and
   includes a bulging portion (bulging portion 50) that is a part of the partition plate including an upper end portion of the partition plate at which the oblique side and the facing side intersect each other and extending from the oblique side to the facing side, and that bulges toward a side opposite to the electrical device along the first direction.

According to the battery pack in the above (1), when a load is input to the side wall of the case body, the facing side of the partition plate is abutted with the side wall to generate a reaction force. Although the partition plate that generates the reaction force is deformed, since the bulging portion bulges in advance to the side opposite to the electrical device along the first direction, bulging of the partition plate due to the deformation is guided to the side opposite to the electrical device. Accordingly, contact between the deformed partition plate and the electrical device can be prevented, and the electrical device can be protected.

(2) The battery pack according to the above (1), in which
a lower edge (lower edge LE) of the bulging portion that extends from the oblique side to the facing side has a bent portion (bent portion 51), and
the bent portion is located closer to the facing side than a start point (start point 52) of the lower edge on the oblique side and is located lower than the start point.

According to the battery pack in the above (2), the bulging of the partition plate due to the deformation can be generated starting from the bent portion, and the bulging of the partition plate due to the deformation can be controlled.

(3) The battery pack according to the above (2), in which
the lower edge extends along the oblique side from the bent portion to the facing side.

According to the battery pack in the above (3), a compressive force along the oblique side of the partition plate generated by the abuttment between the facing side of the partition plate and the side wall of the case body can effectively act on the bulging portion.

(4) The battery pack according to the above (2), in which
the start point of the lower edge on the oblique side is located lower than an upper end of the side wall of the case body.

According to the battery pack in the above (4), the load input to the partition plate overlaps the bulging portion, and the compressive force can effectively act on the bulging portion.

(5) The battery pack according to the above (1), in which
an upper end of the facing side of the partition plate is located higher than an upper end of the side wall of the case body.

According to the battery pack in the above (5), an input from a side portion of the case cover overlapping the side wall in addition to the side wall of the case body can also be received.

(6) The battery pack according to the above (1), in which
the reinforcing member includes a fixing plate (fixing plate 30) that fixes the electrical device to the bottom wall of the case body, and
the partition plate is integrally formed with the fixing plate to extend from the fixing plate and is bent and raised relative to the fixing plate.

According to the battery pack in the above (6), a reduction in the number of components in the battery pack and improvement in assemblability are achieved.

(7) The battery pack according to the above (6), in which
the reinforcing member includes a doubling plate (doubling plate 32) disposed between the electrical device and the side wall of the case body and joined to the side wall, and
the doubling plate is integrally formed with the fixing plate to extend from the fixing plate and is bent and raised relative to the fixing plate.

According to the battery pack in the above (7), rigidity of the side wall of the case body can be increased, and deformation of the side wall can be guided to the partition plate. Further, the reduction in the number of components in the battery pack and the improvement in the assemblability are achieved.

(8) The battery pack according to the above (7), in which
the partition plate and the doubling plate are separated from each other.

According to the battery pack in the above (8), moldability of the fixing plate, the partition plate, and the doubling plate which are integrally formed is improved.

(9) The battery pack according to the above (7), in which
an upper end of the doubling plate is located lower than an upper end of the side wall of the case body.

According to the battery pack in the above (9), the deformation of the side wall of the case body can be more reliably controlled without being affected by the deformation of the side portion of the case cover overlapping the side wall of the case body.

(10) The battery pack according to the above (6), in which
the partition plate has an abutting portion (abutting portion 43) extending from the facing side toward the side opposite to the electrical device along the first direction.

According to the battery pack in the above (10), displacement of the facing side of the partition plate toward the electrical device can be prevented, and the contact between the deformed partition plate and the electrical device can be more reliably prevented.

(11) The battery pack according to the above (10), in which
a cutout (cutout 44) is provided at a corner portion of the partition plate at which the facing side and the base side intersect each other.

According to the battery pack in the above (11), an edge portion of the partition plate along the facing side can be buckled toward the side opposite to the electrical device, and the contact between the deformed partition plate and the electrical device can be more reliably prevented.

### REFERENCE SIGNS LIST

1 vehicle
2 vehicle body
3 seat
4 floor panel
10 battery pack
11 battery
12 case
13 case body
14 case cover
15 junction box
24 side wall
30 fixing plate
31 partition plate
32 doubling plate
40 base side
41 oblique side
42 facing side
43 abutting portion
44 cutout
45 distal end
50 bulging portion
51 bent portion
52 start point
LE lower edge
M motor

What is claimed is:

1. A battery pack comprising:
a battery;
an electrical device connected to the battery;
a case including a case body accommodating the battery and the electrical device, and a case cover covering an upper side of the case body; and
a reinforcing member provided inside the case, wherein the case body has a bottom wall on which the battery and the electrical device are placed, and a side wall extending in a first direction parallel to the bottom wall,
the electrical device is disposed adjacent to the side wall in a second direction parallel to the bottom wall and perpendicular to the first direction,
the reinforcing member includes a partition plate disposed adjacent to the electrical device in the first direction and adjacent to the side wall in the second direction, and
the partition plate
as viewed in the first direction, is formed in a triangular shape having a base side extending toward the side wall of the case body along the second direction, an oblique side inclined such that the oblique side departs from the base side toward the side wall, and a facing side facing the side wall in the second direction, and
includes a bulging portion that is a part of the partition plate including an upper end portion of the partition plate at which the oblique side and the facing side intersect each other and extending from the oblique side to the facing side, and that bulges toward a side opposite to the electrical device along the first direction.

2. The battery pack according to claim 1, wherein
a lower edge of the bulging portion that extends from the oblique side to the facing side has a bent portion, and
the bent portion is located closer to the facing side than a start point of the lower edge on the oblique side and is located lower than the start point.

3. The battery pack according to claim 2, wherein
the lower edge extends along the oblique side from the bent portion to the facing side.

4. The battery pack according to claim 2, wherein
the start point of the lower edge on the oblique side is located lower than an upper end of the side wall of the case body.

5. The battery pack according to claim 1, wherein
an upper end of the facing side of the partition plate is located higher than an upper end of the side wall of the case body.

6. The battery pack according to claim 1, wherein
the reinforcing member includes a fixing plate that fixes the electrical device to the bottom wall of the case body, and
the partition plate is integrally formed with the fixing plate to extend from the fixing plate and is bent and raised relative to the fixing plate.

7. The battery pack according to claim 6, wherein
the reinforcing member includes a doubling plate disposed between the electrical device and the side wall of the case body and joined to the side wall, and
the doubling plate is integrally formed with the fixing plate to extend from the fixing plate and is bent and raised relative to the fixing plate.

8. The battery pack according to claim 7, wherein the partition plate and the doubling plate are separated from each other.

9. The battery pack according to claim 7, wherein
an upper end of the doubling plate is located lower than an upper end of the side wall of the case body.

10. The battery pack according to claim 6, wherein
the partition plate has an abutting portion extending from the facing side toward a side opposite to the electrical device along the first direction.

11. The battery pack according to claim 10, wherein
a cutout is provided at a corner portion of the partition plate at which the facing side and the base side intersect each other.
